(19) United States
(12) Patent Application Publication
(10) Pub. No.: US 2026/0361410 A1
(43) Pub. Date: Nov. 12, 2026

(54) CONTROL APPARATUS, COMMUNICATION SYSTEM AND CONTROL METHOD

(71) Applicant: NTT, Inc., Tokyo (JP)

(72) Inventors: Shin KANEKO, Musashino-shi (JP); Yasutaka KIMURA, Musashino-shi (JP); Naotaka SHIBATA, Musashino-shi (JP); Junichi KANI, Musashino-shi (JP)

(73) Assignee: NTT, Inc., Tokyo (JP)

(21) Appl. No.: 19/125,158

(22) PCT Filed: Nov. 30, 2022
(86) PCT No.: PCT/JP2022/044162

§ 371 Date: Apr. 28, 2025

(51) Int. Cl. H04B 10/27; H04L 41/34; H04L 43/0864

(52) U.S. Cl. CPC H04B 10/27; H04L 41/34; H04L 43/0864

(57) ABSTRACT

A control device includes: an optical distribution control unit that dynamically changes connection such that downlink control signal light obtained by time-division multiplexing downlink control signals for the respective subscriber devices, which are input from control ports to an optical distribution unit is distributed and output toward a destination subscriber device of the downlink control signals, and dynamically changes the connection such that uplink control signal light obtained by time-multiplexing of uplink control signal light input from a plurality of subscriber devices to the optical distribution unit is output to a control port; and a subscriber device management control unit that transmits an instruction of each timing of outputting the uplink control signal light toward the optical distribution unit such that the uplink control signal light is output to the control port. The wavelength of the main signal light output from the subscriber device toward the optical distribution unit is different from the wavelength of the uplink control signal light. The wavelength of the main signal light output from the optical distribution unit toward the subscriber device is different from the wavelength of the downlink control signal light. The optical distribution unit outputs the uplink control signal light to the control port, and distributes the downlink control signal light toward the destination subscriber device of the downlink control signal.

### TECHNICAL FIELD

The present invention relates to a control apparatus, a communication system, and a control method.

### BACKGROUND ART

Facing communication devices (subscriber devices) may communicate with each other via an opened optical path. FIG. 7 is a diagram illustrating a configuration example of a communication system before opening of an optical path. The communication system illustrated in FIG. 7 includes an optical transmission line group 100, an optical distribution unit 200, an optical distribution control unit 300, a subscriber device management control unit 400, an optical transmission line group 500 (optical fiber group), and a wavelength multiplexing/demultiplexing unit on the side of a subscriber device “#k_1 (k=1, 2, . . . )” with respect to an optical communication network.

The configuration on the side of a subscriber device “#k_2 (k=1, 2, . . . )” with respect to the optical communication network is similar to the configuration on the side of the subscriber device “#k_1”. In addition, the wavelength multiplexing/demultiplexing unit on the side of the subscriber device “#k_1” is connected to the wavelength multiplexing/demultiplexing unit on the side of the subscriber device “#k_2” via the optical communication network.

In the optical distribution unit 200, an optical transmission line of the optical transmission line group 100 is connected in advance to a signal port on a side to which the subscriber device “#k_1” is connected. In addition, an optical transmission line of the optical transmission line group 500 is connected in advance to a signal port on the side to which the wavelength multiplexing/demultiplexing unit is connected.

The subscriber device “#k_1” is connected to the optical distribution unit 200 via an optical transmission line of the optical transmission line group 100. In the optical distribution unit 200, a connection relationship between the signal port on the side to which the subscriber device “#k_1” is connected and the signal port on the side of the wavelength multiplexing/demultiplexing unit is changed by the optical distribution control unit 300 according to the setting by the optical distribution control unit 300.

In a case where the subscriber device “#k_1” is connected to the optical transmission line of the optical transmission line group 100 (at the time of initial connection), the subscriber device “#k_1” outputs uplink control signal light toward the optical distribution unit 200. In the optical distribution unit 200, the uplink control signal light input from the subscriber device “#k_1” to the signal port on the subscriber device “#k_1” side is output to the subscriber device management control unit 400 via a signal port of the optical distribution unit 200 to which the uplink control signal light is transferred, based on the connection relationship set by the optical distribution control unit 300.

In addition, the subscriber device management control unit 400 outputs downlink control signal light toward a signal port on the wavelength multiplexing/demultiplexing unit side in the optical distribution unit 200. In the optical distribution unit 200, the downlink control signal light input from the subscriber device management control unit 400 is output to the subscriber device “#k_1” via a signal port to which the downlink control signal light is transferred, based on the connection relationship set by the optical distribution control unit 300.

For example, in a case where a subscriber device “#1_1” is connected to the optical transmission line of the optical transmission line group 100 (at the time of initial connection), the optical distribution control unit 300 connects signal ports in the optical distribution unit 200 such that the subscriber device “#1_1” is connected to the subscriber device management control unit 400. Here, the subscriber device management control unit 400 performs communication of information necessary for registration and authentication of the subscriber device “#1_1” with the subscriber device “#1_1”. In addition, the subscriber device management control unit 400 transmits an instruction of a wavelength of an optical signal of the subscriber device “#1_1” to the subscriber device “#1_1” by using downlink control signal light.

FIG. 8 is a diagram illustrating a configuration example of a communication system after opening of an optical path. In a case where the registration and authentication of the subscriber device “#1_1”, the setting of the wavelength of an optical signal, and the like are completed, the optical distribution control unit 300 changes the connection relationship between the signal ports in the optical distribution unit 200 such that the optical signal transmitted from the subscriber device “#1_1” is transmitted to the subscriber device “#1_2”.

As a result, the optical distribution unit 200 outputs the main signal light input from the subscriber device “#k_1” to the signal port on the subscriber device “#k_1” side, from the signal port on the side of the wavelength multiplexing/demultiplexing unit in the optical distribution unit 200 based on the connection relationship set by the optical distribution control unit 300. Similarly, the optical distribution unit 200 outputs the main signal light input from the wavelength multiplexing/demultiplexing unit to the signal port on the wavelength multiplexing/demultiplexing unit side, from the signal port on the subscriber device “#k_1” side in the optical distribution unit 200 based on the connection relationship set by the optical distribution control unit 300. As described above, the subscriber device “#k_1” and the subscriber device “#k_2” communicate with each other via the opened optical path.

### CITATION LIST

### Non Patent Document

Non Patent Document 1:6 persons including Kanai, “Photonic Gateway for All-Photonics Network,” IEICE General Conference, B-8-20, March 2021.

### SUMMARY OF INVENTION

### Technical Problem

However, in the communication system after the opening of the optical path, there is no control channel for transmitting and receiving control signal light between the subscriber device management control unit 400 and the subscriber device. Therefore, it is conceivable to newly provide a control port for transmitting and receiving control signal light in the subscriber device management control unit 400 in order to provide a control channel for transmitting and receiving control signal light between the subscriber device management control unit 400 and the subscriber device.

FIG. 9 is a diagram illustrating a configuration example of a communication system including a control channel for a subscriber device after opening of an optical path. The communication system illustrated in FIG. 9 includes an optical transmission line group 100 (optical fiber group), an optical distribution unit 200, an optical distribution control unit 300, a subscriber device management control unit 400, an optical transmission line group 500 (optical fiber group), and a wavelength multiplexing/demultiplexing unit on the side of a subscriber device “#k_1 (k=1, 2, . . . )”. The subscriber device management control unit 400 includes a control port “a” and one or more control ports 410 “b”.

The configuration on the side of a subscriber device “#k_2 (k=1, 2, . . . )” is similar to the configuration on the side of the subscriber device “#k_1”. The wavelength multiplexing/demultiplexing unit on the side of the subscriber device “#k_1” is connected to the wavelength multiplexing/demultiplexing unit on the side of the subscriber device “#k_2” via the optical communication network. Each optical transmission line of the optical transmission line group 500 includes an optical multiplexing/demultiplexing unit 600.

Before opening of an optical path, the subscriber device management control unit 400 performs communication of information necessary for registration and authentication of the subscriber device “#k_1” connected to the optical distribution unit 200 with the subscriber device “#k_1” by using the control port “a”. In addition, the subscriber device management control unit 400 transmits an instruction of the wavelength of the optical signal (main signal light) to the subscriber device “#k_1” by using downlink control signal light transmitted from the control port “a”.

After the opening of the optical path, the subscriber device management control unit 400 transmits and receives control signal light to and from the subscriber device “#k_1” by using the control port 410 “b”. For example, the subscriber device management control unit 400 transmits an instruction of the wavelength of the optical signal (main signal light) to the subscriber device “#k_1” by using the downlink control signal light transmitted from the control port 410 “b”.

After the opening of the optical path, the optical multiplexing/demultiplexing unit 600 branches uplink control signal light transmitted from the subscriber device “#k_1” in the optical transmission line of the optical transmission line group 500, and outputs the uplink control signal light to the subscriber device management control unit 400. The optical multiplexing/demultiplexing unit 600 multiplexes the downlink control signal light transmitted from the subscriber device management control unit 400 with the main signal light output from the subscriber device “#k_2” to the subscriber device “#k_1” on the optical transmission line of the optical transmission line group 500, and outputs the multiplexed light to the subscriber device “#k_1”.

Here, the wavelength of the downlink control signal light is different from the wavelength of the main signal light. As a result, even when the frequency band of the downlink control signal overlaps the frequency band of the main signal in the communication system, the received main signal and downlink control signal do not interfere with each other in the subscriber device “#k_1”. The subscriber device “#k_1” wavelength-separates the main signal light and the downlink control signal light from each other. The subscriber device “#k_1” performs wave detection processing and demodulation processing on each of the separated main signal light and the separated control signal light.

However, in such a configuration, since the control port 410 “b” is required for each optical path connecting the subscriber devices, the configuration of the subscriber device management control unit 400 is enlarged. In addition, it is necessary to provide the optical multiplexing/demultiplexing unit 600 for each optical path connecting the subscriber devices, between the optical distribution unit 200 and the wavelength multiplexing/demultiplexing unit.

As described above, unless the system configuration is complicated, there is a problem that a control signal cannot be transmitted and received between the subscriber device management control unit and the subscriber device after the opening of the optical path, without making the system configuration complicated.

In view of the above circumstances, an object of the present invention is to provide a control device, a communication system, and a control method capable of transmitting and receiving a control signal between a subscriber device management control unit and a subscriber device after opening of an optical path, without complicating a system configuration.

### Solution to Problem

According to an aspect of the present invention, a control device includes: an optical distribution control unit that dynamically changes connection between a plurality of signal ports in units of wavelengths such that downlink control signal light obtained by time-division multiplexing downlink control signals for respective subscriber devices, which are input from control ports to an optical distribution unit having the plurality of signal ports, is distributed and output toward destination subscriber devices of the downlink control signals, and dynamically changes the connection in units of wavelengths such that uplink control signal light obtained by time-multiplexing uplink control signal light input from the plurality of subscriber devices to the optical distribution unit is output to the control port; and a subscriber device management control unit that transmits, to the plurality of subscriber devices, an instruction of each timing at which the uplink control signal light is output toward the optical distribution unit, such that the uplink control signal light is output to the control port. A wavelength of main signal light output from the subscriber device toward the optical distribution unit is different from a wavelength of the uplink control signal light, and a wavelength of main signal light output from the optical distribution unit toward the subscriber device is different from a wavelength of the downlink control signal light. The optical distribution unit outputs the uplink control signal light to the control port and distributes the downlink control signal light toward a destination subscriber device for the downlink control signal.

According to another aspect of the present invention, a communication system includes: an optical distribution unit that has a plurality of signal ports; an optical distribution control unit that dynamically changes connection between the plurality of signal ports in units of wavelengths such that downlink control signal light obtained by time-division multiplexing downlink control signals for respective subscriber devices, which are input from control ports to the optical distribution unit, is distributed and output toward destination subscriber devices of the downlink control signals, and dynamically changes the connection in units of wavelengths such that uplink control signal light obtained by time-multiplexing uplink control signal light input from the plurality of subscriber devices to the optical distribution unit is output to the control port; and a subscriber device management control unit that transmits, to the plurality of subscriber devices, an instruction of each timing at which the uplink control signal light is output toward the optical distribution unit, such that the uplink control signal light is output to the control port. A wavelength of main signal light output from the subscriber device toward the optical distribution unit is different from a wavelength of the uplink control signal light, and a wavelength of main signal light output from the optical distribution unit toward the subscriber device is different from a wavelength of the downlink control signal light. The optical distribution unit outputs the uplink control signal light to the control port and distributes the downlink control signal light toward a destination subscriber device for the downlink control signal.

According to still another aspect of the present invention, a control method is performed by a control device. The control method includes: a step of dynamically changing connection between a plurality of signal ports in units of wavelengths such that downlink control signal light obtained by time-division multiplexing downlink control signals for respective subscriber devices, which are input from control ports to an optical distribution unit having the plurality of signal ports, is distributed and output toward destination subscriber devices of the downlink control signals, and dynamically changing the connection in units of wavelengths such that uplink control signal light obtained by time-multiplexing uplink control signal light input from the plurality of subscriber devices to the optical distribution unit is output to the control port; and a step of transmitting, to the plurality of subscriber devices, an instruction of each timing at which the uplink control signal light is output toward the optical distribution unit, such that the uplink control signal light is output to the control port. A wavelength of main signal light output from the subscriber device toward the optical distribution unit is different from a wavelength of the uplink control signal light, and a wavelength of main signal light output from the optical distribution unit toward the subscriber device is different from a wavelength of the downlink control signal light. The step of changing includes outputting the uplink control signal light to the control port by the optical distribution unit and distributing the downlink control signal light toward a destination subscriber device for the downlink control signal by the optical distribution unit.

### Advantageous Effects of Invention

According to the present invention, it is possible to transmit and receive a control signal between a subscriber device management control unit and a subscriber device after opening of an optical path, without complicating a system configuration.

### BRIEF DESCRIPTION OF DRAWINGS

FIG. 1 A diagram illustrating a configuration example of a communication system 1a according to a first embodiment.

FIG. 2 A sequence diagram illustrating an operation example of the communication system 1a after opening of an optical path, in the first embodiment.

FIG. 3 A diagram illustrating a configuration example of a communication system 1b in a modification example of the first embodiment.

FIG. 4 A diagram illustrating a configuration example of a communication system 1c before opening of an optical path, according to a second embodiment.

FIG. 5 A diagram illustrating a configuration example of the communication system 1c after the opening of the optical path, in the second embodiment.

FIG. 6 A diagram illustrating a hardware configuration example of a control device in each embodiment.

FIG. 7 A diagram illustrating a configuration example of the communication system before opening of the optical path.

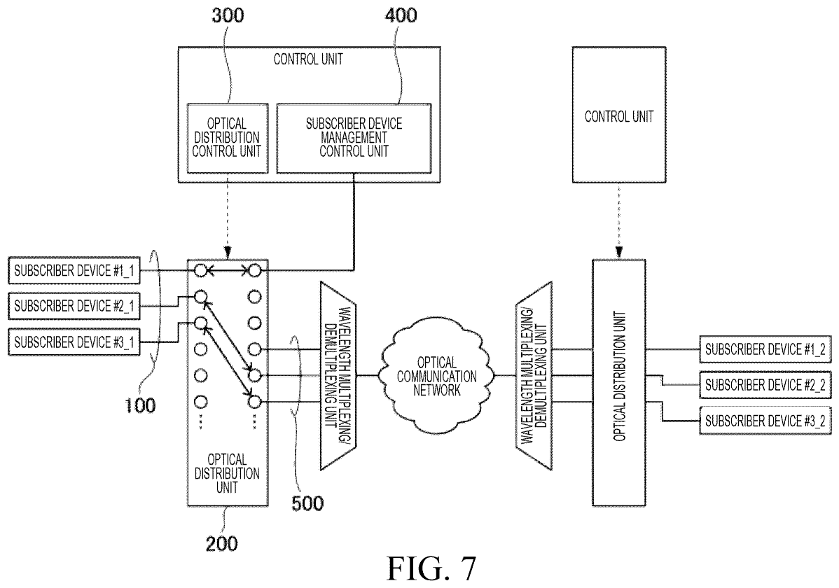

FIG. 8 A diagram illustrating a configuration example of the communication system after the opening of the optical path.

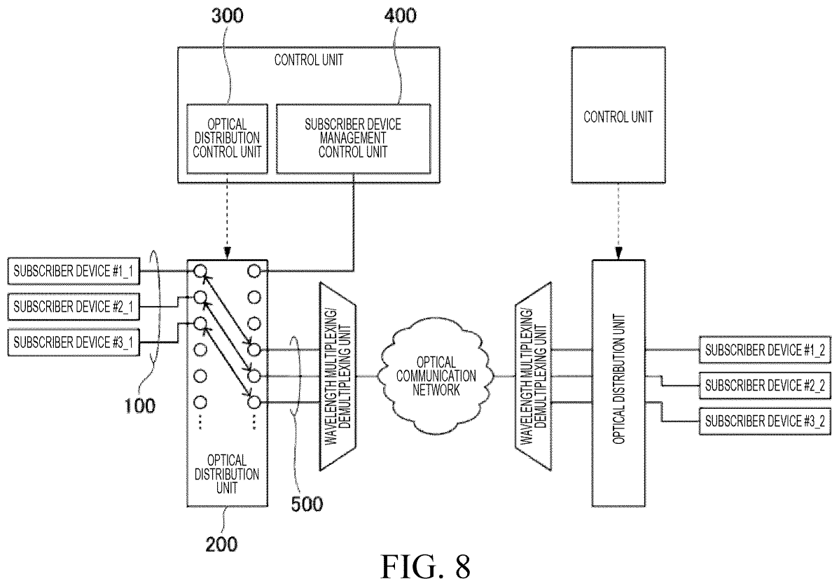

FIG. 9 A diagram illustrating a configuration example of a communication system including a control channel for a subscriber device after the opening of the optical path.

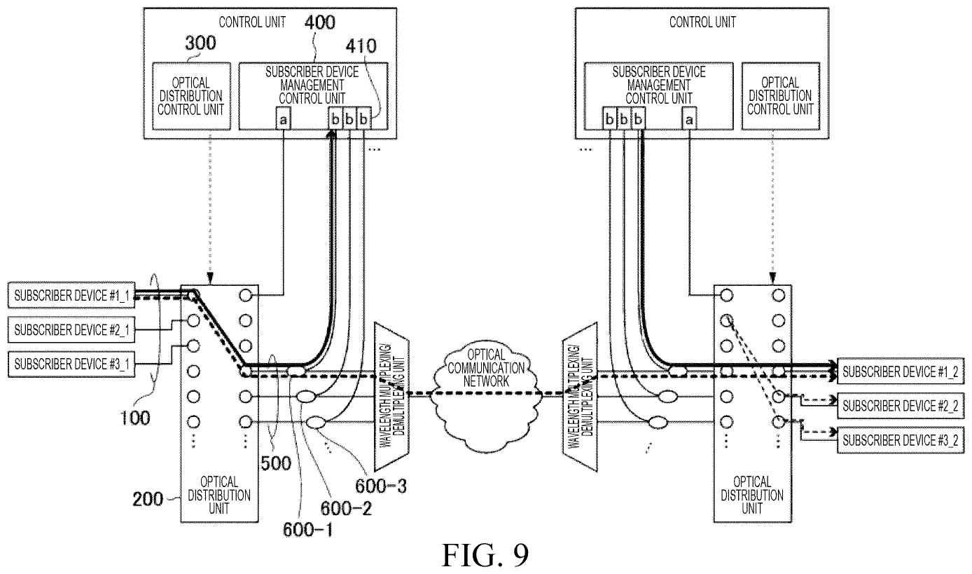

### DESCRIPTION OF EMBODIMENTS

Embodiments of the present invention will be described in detail with reference to the drawings.

### First Embodiment

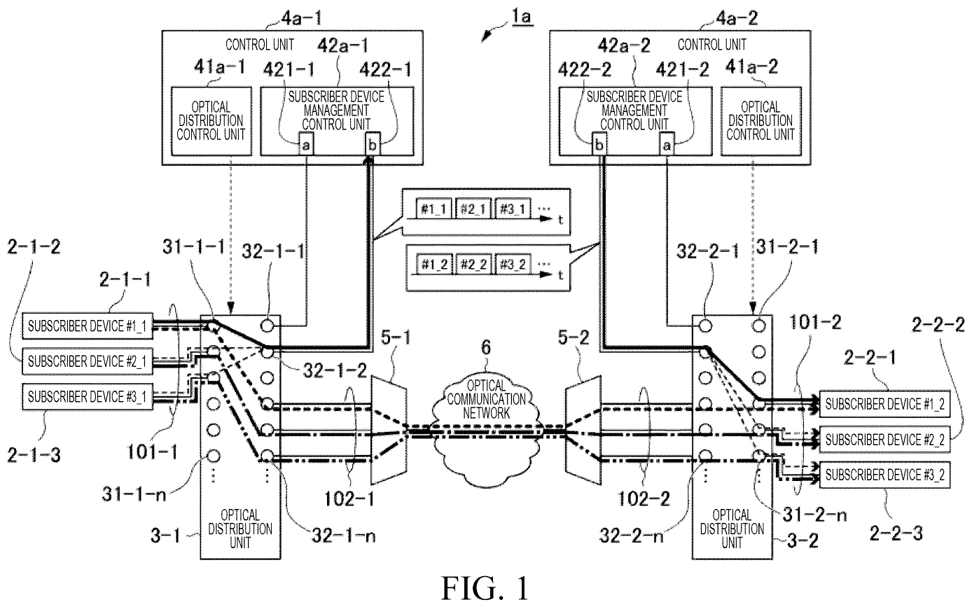

FIG. 1 is a diagram illustrating a configuration example of a communication system 1a according to a first embodiment. The communication system 1a includes one or more subscriber devices 2-1, an optical distribution unit 3-1 (control device), a control unit 4a-1 (control device), a wavelength multiplexing/demultiplexing unit 5-1 (control device), an optical transmission line group 101-1 (optical fiber group), and an optical transmission line group 102-1 (optical fiber group).

In addition, the communication system 1a includes one or more subscriber devices 2-2 facing one or more subscriber devices 2-1, an optical distribution unit 3-2 (control device), a control unit 4a-2 (control device), a wavelength multiplexing/demultiplexing unit 5-2 (control device), an optical transmission line group 101-2 (optical fiber group), and an optical transmission line group 102-2 (optical fiber group).

The subscriber device 2 is connected to an optical transmission line of the optical transmission line group 101. In addition, the wavelength multiplexing/demultiplexing unit 5-1 and the wavelength multiplexing/demultiplexing unit 5-2 are connected via an optical communication network 6 by using one or more optical transmission lines.

The configuration of the subscriber device 2-2 is similar to the configuration of the subscriber device 2-1. The configuration of the optical distribution unit 3-2 is similar to the configuration of the optical distribution unit 3-1. The configuration of the control unit 4a-2 is similar to the configuration of the control unit 4a-1. The configuration of the wavelength multiplexing/demultiplexing unit 5-2 is similar to the configuration of the wavelength multiplexing/demultiplexing unit 5-1.

Therefore, the configuration of the communication system 1a will be described below by using mainly the subscriber device 2-1, the optical distribution unit 3-1, the control unit 4a-1, and the wavelength multiplexing/demultiplexing unit 5-1 among the subscriber device 2-1, the optical distribution unit 3-1, the control unit 4a-1, the wavelength multiplexing/demultiplexing unit 5-1, the subscriber device 2-2, the optical distribution unit 3-2, the control unit 4a-2, and the wavelength multiplexing/demultiplexing unit 5-2.

The optical distribution unit 3-1 includes one or more signal ports 31-1-n (n is an integer of 1 or more) and one or more signal ports 32-1-n. The signal port 31-1 is connected in advance to the optical transmission line group 101-1. The signal port 32-1 is connected in advance to an optical transmission line of the optical transmission line group 102-1. The optical transmission line group 102-1 is connected to the wavelength multiplexing/demultiplexing unit 5-1.

The control unit 4a-1 includes an optical distribution control unit 41a-1 and a subscriber device management control unit 42a-1. The subscriber device management control unit 42a-1 includes a control port 421-1 “a” and a control port 422-1 “b”.

The control unit 4a-1 may include a plurality of control ports 422-1 “b”. In a case where the control unit 4a-1 includes a plurality of control ports 422-1 “b”, as compared with a case where the control unit 4a-1 includes one control port 422-1 “b”, the number of accommodated subscriber devices 2-1 for each control port 422-1 “b” is reduced, so that the available band for each subscriber device 2-1 is increased. Since the band used for the control signal may be different for each subscriber device 2-1, the number of the subscriber devices 2-1 accommodated in the control port 422-1 “b” may be determined for each control port 422-1 “b”. In addition, the control unit 4a-1 may freely determine which subscriber device 2-1 is accommodated in the control port 422-1 “b”.

In the following description, the subscriber device 2-1 faces the subscriber device 2-2. The wavelength of an optical signal (uplink control signal light) for carrying an uplink control signal transmitted to the subscriber device management control unit 42a-1 by the subscriber device 2-1 is different from the wavelength of an optical signal (main signal light) for carrying a main signal transmitted to the subscriber device 2-2 by the subscriber device 2-1. In addition, the wavelength of an optical signal (downlink control signal light) for carrying a downlink control signal transmitted to the subscriber device 2-1 by the subscriber device management control unit 42a-1 is different from the wavelength of an optical signal (main signal light) for carrying a main signal transmitted to the subscriber device 2-1 by the subscriber device 2-2.

In the following description, the wavelength of the optical signal for carrying the uplink control signal may be different for each subscriber device 2, or may be the same wavelength for a plurality of subscriber devices 2. In addition, the uplink control signal may include, for example, an identifier indicating the subscriber device 2. The identifier may be, for example, information such as a number and an ID assigned to the subscriber device 2, or may be a media access control address (MAC address) of the subscriber device 2.

The optical signal from the subscriber device 2-1 to the subscriber device 2-2 and the optical signal from the subscriber device 2-2 to the subscriber device 2-1 may be transmitted in directions opposite to each other in the same optical fiber core wire in at least some sections of the optical transmission line. In other words, the optical signal from the subscriber device 2-1 to the subscriber device 2-2 and the optical signal from the subscriber device 2-2 to the subscriber device 2-1 may be transmitted in different optical fiber core wires in at least some sections of the optical transmission line.

### <Subscriber Device 2>

Before opening of an optical path, the subscriber device 2-1 outputs uplink control signal light toward the control port 421-1 “a” of the subscriber device management control unit 42a-1. The uplink control signal light reaches the control port 421-1 “a” of the subscriber device management control unit 42a-1 via the signal port 31-1 and the signal port 32-1 of the optical distribution unit 3-1. The uplink control signal before the opening of the optical path includes, for example, information necessary for registration, authentication, and the like of the subscriber device 2-1.

Before the opening of the optical path, downlink control signal light output from the control port 421-1 “a” of the subscriber device management control unit 42a to the subscriber device 2-1 reaches the subscriber device 2-1 via the signal port 32-1 and the signal port 31-1 of the optical distribution unit 3-1. The downlink control signal before the opening of the optical path includes, for example, information necessary for registration and authentication of the subscriber device 2-1 and a wavelength instruction to the subscriber device 2-1.

After the opening of the optical path, a communication permission period “#k_1” of the uplink control signal and the downlink control signal is assigned to each subscriber device 2-1 by the subscriber device management control unit 42a-1. In the communication permission period “#k_1” assigned to each subscriber device after the opening of the optical path, the subscriber device 2-1 receives the downlink control signal light that is output from the control port 422-1 “b” of the subscriber device management control unit 42a (the downlink control signal light obtained by time-division multiplexing the downlink control signal for each subscriber device 2) and reaches the subscriber device 2-1 via the signal port 32-1 and the signal port 31-1 of the optical distribution unit 3-1. The downlink control signal after the opening of the optical path includes, for example, information indicating the wavelength of the optical signal. The subscriber device 2-1 converts the downlink control signal light into an electrical signal. The subscriber device 2-1 may extract the identifier of the subscriber device 2-1 from the electrical signal. As a result, the subscriber device 2-1 can recognize, based on the extracted identifier, that the received downlink control signal is a downlink control signal for the subscriber device 2-1.

In the communication permission period “#k_1”, the subscriber device 2-1 outputs the uplink control signal light toward the signal port 31-1 of the optical distribution unit 3-1. The uplink control signal light is output toward the control port 422-1 “b” of the subscriber device management control unit 42a via the signal port 31-1 and the signal port 32-1 of the optical distribution unit 3-1.

After the opening of the optical path, the subscriber device 2-1 outputs main signal light toward the facing subscriber device 2-2. After the opening of the optical path, the main signal light output from the subscriber device 2-2 facing the subscriber device 2-1 toward the subscriber device 2-1 reaches the subscriber device 2-1 via the signal port 31-1 and the signal port 32-1 of the optical distribution unit 3-1.

After the opening of the optical path, the subscriber device 2-1 wavelength-separates the main signal light and the downlink control signal light. The subscriber device 2-1 performs wave detection processing and demodulation processing on each of the separated main signal light and the separated control signal light.

### <Optical Distribution Unit 3>

The optical distribution unit 3-1 is, for example, a wavelength selective switch (WSS). The connection relationship between the signal port 31-1 and the signal port 32-1 can be freely changed (switched) in units of wavelengths.

Before the opening of the optical path, the connection relationship between the signal port 31-1 and the signal port 32-1 in the optical distribution unit 3-1 is changed by the optical distribution control unit 41a-1 (selection unit) such that the uplink control signal light transmitted from the newly connected subscriber device 2-1 is output toward the control port 421-1 “a”. In addition, before the opening of the optical path, the connection relationship between the signal port 31-1 and the signal port 32-1 in the optical distribution unit 3-1 is changed by the optical distribution control unit 41a-1 such that the downlink control signal light transmitted from the control port 421-1 “a” is output toward the newly connected subscriber device 2-1.

After the opening of the optical path, the optical distribution unit 3-1 distributes an optical signal input from the signal port 31-1 to the signal port 32-1 for each wavelength of the optical signal based on the connection relationship (selection result of the signal port) instructed from the optical distribution control unit 41a-1 for the signal port. For the wavelength of the uplink control signal light, in the communication permission period “#k_1”, the connection relationship between the signal ports in the optical distribution unit 3-1 is set such that the uplink control signal light input from the subscriber device 2-1 to which the communication permission period “#k_1” is assigned is output to the signal port 32-2. As a result, the respective rays of uplink control signal light input from the plurality of subscriber devices 2-1 to the optical distribution unit 3-1 are time-multiplexed, and the time-multiplexed uplink control signal light is output toward the control port 422-1 “b”.

After the opening of the optical path, the optical distribution unit 3-1 distributes an optical signal input from the signal port 32-1 to the signal port 31-1 for each wavelength of the optical signal based on the connection relationship instructed from the optical distribution control unit 41a-1 for the signal port. For the wavelength of the uplink control signal light, in the communication permission period “#k_1”, the connection relationship between the signal ports in the optical distribution unit 3-1 is set such that the downlink control signal light input from the control port 422-1 “b” is output to the signal port 32-1 connected to the subscriber device 2-1 to which the communication permission period “#k_1” is assigned. Here, the control port 422-1 “b” outputs the downlink control signal light obtained by time-division multiplexing the downlink control signals for the respective subscriber devices such that the downlink control signal for the subscriber device 2-1 reaches the signal port 32-2 in the communication permission period “#k_1” assigned to the subscriber device 2-1. As a result, the downlink control signal light obtained by time-division multiplexing the downlink control signals for the respective subscriber devices, which are input from the control port 422-1 “b” to the optical distribution unit 3-1, is distributed and output toward the respective destination subscriber devices 2-1.

After the opening of the optical path, the optical distribution unit 3 outputs the main signal light input from the subscriber device 2-1 to the signal port 31-1, to the wavelength multiplexing/demultiplexing unit 5-1 from the signal port 32-1 in the optical distribution unit 3-1 based on the connection relationship set by the optical distribution control unit 41a-1. Similarly, the optical distribution unit 3-1 outputs the main signal light input from the wavelength multiplexing/demultiplexing unit 5-1 to the signal port 32-1, to the subscriber device 2-1 from the signal port 31-1 based on the connection relationship set by the optical distribution control unit 41a-1. As described above, the subscriber device 2-1 and the subscriber device 2-2 communicate with each other via the opened optical path. The wavelength of the main signal light transmitted from the subscriber device 2-1 and the wavelength of the main signal light transmitted from the subscriber device 2-2 may be the same or different.

<Optical Distribution Control Unit 41a>

Before the opening of the optical path, the optical distribution control unit 41a-1 (selection unit) changes the connection relationship between the signal port 31-1 and the signal port 32-1 in the optical distribution unit 3-1 such that the uplink control signal light transmitted from the newly connected subscriber device 2-1 is output toward the control port 421-1 “a”. In addition, before the opening of the optical path, the optical distribution control unit 41a-1 changes the connection relationship between the signal port 31-1 and the signal port 32-1 in the optical distribution unit 3-1 such that the downlink control signal light transmitted from the control port 421-1 “a” is output toward the newly connected subscriber device 2-1.

After the opening of the optical path, the optical distribution control unit 41a-1 sets a connection relationship between the signal port 31-1 and the signal port 32-1 in the optical distribution unit 3-1 with respect to the wavelength of the main signal light such that the main signal light transmitted from the subscriber device 2-1 is output toward the subscriber device 2-2 facing the subscriber device 2-1. In addition, after the opening of the optical path, the optical distribution control unit 41a-1 sets a connection relationship between the signal port 31-1 and the signal port 32-1 in the optical distribution unit 3-1 with respect to the wavelength of the main signal light such that the main signal transmitted from the subscriber device 2-2 facing the subscriber device 2-1 is output toward the subscriber device 2-1.

The optical distribution control unit 41a-1 dynamically changes the connection relationship between the signal ports in the optical distribution unit 3-1 with respect to the wavelength of the uplink control signal light under a predetermined condition based on the communication permission period (control permission period) assigned to each subscriber device 2 by the subscriber device management control unit 42a-1 such that the uplink control signal light transmitted from the subscriber device 2-1 after the opening of the optical path is output toward the control port 422-1 “b”. For example, the optical distribution control unit 41a-1 dynamically changes (selects) the signal port 31-1 through which the uplink control signal light is transferred to and from the control port 422-1 “b”, under a predetermined condition based on the communication permission period (control permission period) assigned to each subscriber device 2 by the subscriber device management control unit 42a-1.

In the following description, the predetermined condition is, for example, a condition of a timing (for example, change cycle) of changing the selection of the signal port 31. The timing of changing the selection of the signal port 31 is determined in advance based on, for example, the communication permission period determined according to a round trip time (RIT) of the optical signal for carrying the control signal. Here, the timing of changing the selection of the signal port 31 is determined for each subscriber device 2 such that each of the subscriber device 2 and the control unit 4a-1 can receive the uplink control signal and the downlink control signal. A cycle at which the signal port 31 is dynamically selected may be, for example, the same for all the signal ports 31. The cycle at which the signal port 31 is dynamically selected may be different for each signal port 31 according to, for example, the communication amount of the main signal in the signal port 31.

The optical distribution control unit 41a-1 dynamically changes the connection relationship between the signal ports in the optical distribution unit 3-1 with respect to the wavelength of the downlink control signal under a predetermined condition based on the communication permission period (control permission period) assigned to each subscriber device 2 by the subscriber device management control unit 42a-1 such that the downlink control signal light obtained by time-division multiplexing the downlink control signals for the respective subscriber devices, which is transmitted from the control port 422-1 “b” after the opening of the optical path, is distributed and output toward the subscriber device 2-1 as a transmission destination of the downlink control signal. For example, the optical distribution control unit 41a-1 dynamically changes (selects) the signal port 31-1 through which the downlink control signal light is transferred to and from the control port 422-1 “b”, under a predetermined condition based on the communication permission period (control permission period) assigned to each subscriber device 2 by the subscriber device management control unit 42a-1.

<Subscriber Device Management Control Unit 42a>

Before the opening of the optical path, the subscriber device management control unit 42a-1 receives the uplink control signal light that has been output from the newly connected subscriber device 2-1 and has reached the control port 421-1 “a” via the signal port 31-1 and the signal port 32-1 of the optical distribution unit 3-1. Further, before the opening of the optical path, the subscriber device management control unit 42a-1 outputs the downlink control signal light for the newly connected subscriber device 2-1 from the control port 421-1 “a” toward the signal port 32-1 of the optical distribution unit 3-1.

Before the opening of the optical path, the round trip time of the optical signal between the subscriber device 2-1 and the subscriber device management control unit 42a-1 may be measured in advance for each subscriber device 2-1. For example, the subscriber device management control unit 42a measures the round trip time of the optical signal in advance for each subscriber device 2-1 based on the propagation time of the uplink control signal and the propagation time of the downlink control signal.

After the opening of the optical path, the subscriber device management control unit 42a-1 assigns the communication permission period “#k_1” of the uplink control signal and the downlink control signal to each subscriber device 2-1 such that the uplink control signal light and the downlink control signal light are transmitted between the subscriber device 2-1 and the control port 422-1 “b”. In this case, the communication permission period “#k_1” may be assigned based on the round trip time of the optical signal. The communication permission periods “#k_1” of the uplink control signal and the downlink control signal may be different for each subscriber device 2-1.

In the communication permission period assigned to each subscriber device after the opening of the optical path, the subscriber device management control unit 42a-1 transmits the downlink control signal for the subscriber device 2-1 to which this communication permission period is assigned, from the control port 422-1 “b”.

In the communication permission period assigned to each subscriber device after the opening of the optical path, the subscriber device management control unit 42a-1 may transmit, from the control port 422-1 “b”, the downlink control signal for the subscriber device 2-1 to which the communication permission period is assigned, including an identifier indicating the subscriber device 2-1.

In the communication permission period assigned to each subscriber device after the opening of the optical path, the subscriber device management control unit 42a-1 receives the uplink control signal light from the subscriber device 2-1 to which the communication permission period is assigned, at the control port 422-1 “b” via the signal port 31-1 and the signal port 32-1 of the optical distribution unit 3-1. The subscriber device management control unit 42a-1 converts the uplink control signal light into an electrical signal. For example, in a case where the identifier of the subscriber device 2-1 is included in the uplink control signal, the subscriber device management control unit 42a-1 extracts the identifier of the subscriber device 2-1 from the electrical signal. The subscriber device management control unit 42a-1 can recognize the subscriber device 2-1 that has transmitted the uplink control signal based on the identifier of the subscriber device 2-1.

Note that, in a case where there is a section in which optical signals in different transmission directions are transmitted in a single optical fiber core wire, the subscriber device management control unit 42a-1 may transmit a downlink control signal including an instruction to set an output light wavelength of the subscriber device to the subscriber device 2-1 so that the wavelengths of the optical signals in the different transmission directions are different from each other. For example, the subscriber device management control unit 42a-1 sets the wavelength of the optical signal from the subscriber device 2-1 to the subscriber device 2-2 to be different from the wavelength of the optical signal from the subscriber device 2-2 to the subscriber device 2-1. As a result, it is possible to prevent deterioration in reception characteristics of the optical signal in the opposite transmission direction due to the influence of reflection in an optical fiber transmission line or the like. The subscriber device management control unit 42a-1 may assign different communication permission periods to the optical signals in the respective transmission directions for each transmission direction of the optical signal, without necessarily setting the wavelength of the optical signal from the subscriber device 2-1 to the subscriber device 2-2 to be different from the wavelength of the optical signal from the subscriber device 2-2 to the subscriber device 2-1.

In addition, in a case where there is no section in which the optical signals in the different transmission directions are transmitted in the single optical fiber core wire, the subscriber device management control unit 42a-1 may transmit a downlink control signal including an instruction to set the output light wavelength of the subscriber device to the subscriber device 2-1 so that the wavelengths of the optical signals in the different transmission directions are the same as each other. For example, the subscriber device management control unit 42a-1 sets the wavelength of the optical signal from the subscriber device 2-1 to the subscriber device 2-2 to be the same as the wavelength of the optical signal from the subscriber device 2-2 to the subscriber device 2-1.

### <Wavelength Multiplexing/Demultiplexing Unit 5>

The wavelength multiplexing/demultiplexing unit 5-1 performs wavelength multiplexing processing on the main signal light input from the optical distribution unit 3-1. The wavelength multiplexing/demultiplexing unit 5-1 outputs the main signal light subjected to wavelength multiplexing toward the wavelength multiplexing/demultiplexing unit 5-2 via the optical communication network 6. The wavelength multiplexing/demultiplexing unit 5-1 performs wavelength separation processing on the main signal light that is subjected to wavelength multiplexing and is input from the optical communication network 6. The wavelength multiplexing/demultiplexing unit 5-2 outputs the main signal light subjected to wavelength separation toward the optical distribution unit 3-1.

Next, an operation example of the communication system 1a after the opening of the optical path will be described.

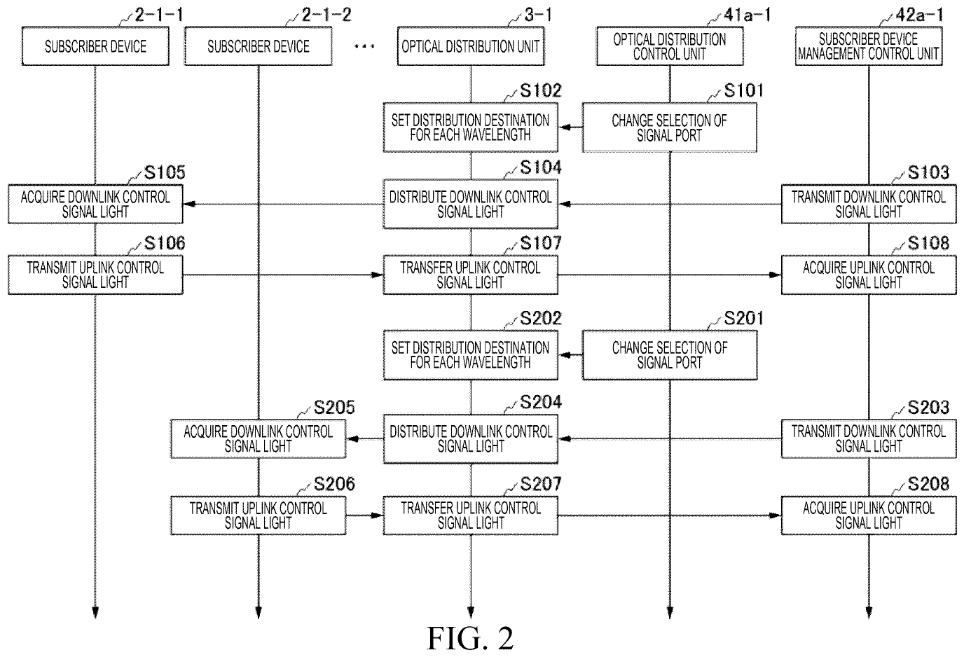

FIG. 2 is a sequence diagram illustrating the operation example of the communication system 1a after the opening of the optical path, in the first embodiment. After the opening of the optical path, the optical distribution control unit 41a-1 dynamically selects the signal port 31-1 from the plurality of signal ports 31 based on a predetermined condition of a change cycle based on, for example, the communication permission period determined according to the round trip time (step S101).

Regarding the uplink control signal light input from the signal port 31-1 and the downlink control signal light input from the signal port 32-1, the optical distribution unit 3-1 sets an optical transmission line (signal port 31-1, signal port 32-1-2) to be distributed, for each wavelength of the optical signal based on the connection relationship (selection result of the signal port 31) instructed from the optical distribution control unit 41a-1 for the signal port (step S102).

The subscriber device management control unit 42a-1 transmits a downlink control signal for the subscriber device 2-1-1 connected to an optical transmission line to which the downlink control signal light is distributed in the communication permission period “#1_1”, by using carrier waves of a predetermined wavelength in the communication permission period (step S103). The optical distribution unit 3-1 distributes downlink control signal light to an optical transmission line (signal port 31-1-1) of a distribution destination associated with the wavelength of the downlink control signal light (step S104). The subscriber device 2-1-1 receives the downlink control signal light output from the signal port 31-1-1 (step S105).

The subscriber device 2-1-1 transmits an uplink control signal toward the signal port 31-1-1 by using carrier waves of a predetermined wavelength (step S106). The optical distribution unit 3-1 transfers the uplink control signal light to an optical transmission line (the control port 422-1) of a distribution destination associated with the wavelength of the uplink control signal light (step S107). The control port 422-1 receives the uplink control signal light output from the signal port 32-1-2 (step S108). Note that the procedure from step S106 to step S108 may be executed before the procedure from step S103 to step S105.

In the subscriber device 2-1-2, the operation from step S201 to step S208 is similar to the operation from step S101 to step S108. Note that the procedure from step S206 to step S208 may be executed before the procedure from step S203 to step S205.

As described above, the optical distribution unit 3 includes the plurality of signal ports 31 and the plurality of signal ports 32. The optical distribution control unit 41a dynamically changes the connection between the plurality of signal ports 31 and the signal port 32 connected to the subscriber device management control unit 42a, in units of wavelengths, such that the downlink control signal light obtained by time-division multiplexing the downlink control signals for the respective subscriber devices 2, which are input from the control port 422 to the optical distribution unit 3, is distributed and output toward the subscriber devices 2 as destinations of the downlink control signals. The optical distribution control unit 41a dynamically changes the connection between the plurality of signal ports 31 and the signal port 32 connected to the subscriber device management control unit 42a, in units of wavelengths, such that rays of the uplink control signal light input from the plurality of subscriber devices 2 to the optical distribution unit 3 are time-multiplexed and output toward the control port 422. The subscriber device management control unit 42a transmits, to each of the subscriber devices 2, an instruction of a timing at which each ray of uplink control signal light is output toward the optical distribution unit 3, such that rays of the uplink control signal light output from the respective subscriber devices 2 are time-multiplexed and output toward the control port 422. Here, the wavelength of the main signal light output from the subscriber device 2 that transmits the uplink control signal light toward the optical distribution unit 3 is different from the wavelength of this uplink control signal light. Further, the wavelength of the main signal light output from the optical distribution unit 3 toward the subscriber device 2 that receives the downlink control signal light is different from the wavelength of this downlink control signal light. Each timing (for example, a switching timing of the communication permission period “#k_1”) may be determined based on the round trip time of the optical signal between each of the plurality of subscriber devices 2 and the control port 422.

As a result, it is possible to transmit and receive the control signal between the subscriber device management control unit 42a and the subscriber device 2 after the opening of the optical path, without complicating the system configuration.

Since the control port 422 of the subscriber device management control unit 42a is shared by the plurality of subscriber devices 2, even though a signal port is not added for each optical path (even though the configuration of the control unit 4a is simple), the control unit 4a can transmit and receive the control signal to and from the subscriber device management control unit 42a after the opening of the optical path. In addition, by using the optical distribution unit (for example, WSS) in which the connection relationship between the signal ports can be set not in units of signal ports but in units of wavelengths, it is possible to realize wavelength separation of the uplink control signal light and the main signal light and wavelength multiplexing of the downlink control signal light and the main signal light, by the optical distribution unit 3. As a result, even though an optical component such as an optical multiplexing/demultiplexing unit is not added to the optical transmission line, the control unit 4a can transmit and receive the control signal to and from the subscriber device management control unit 42a after the opening of the optical path.

### Modification Example of First Embodiment

The communication system does not need to include the wavelength multiplexing/demultiplexing unit 5 that performs the wavelength multiplexing processing and the separation processing on the main signal. In a modification example of the first embodiment, the optical distribution unit 3 performs wavelength multiplexing processing and wavelength separation processing on the main signal.

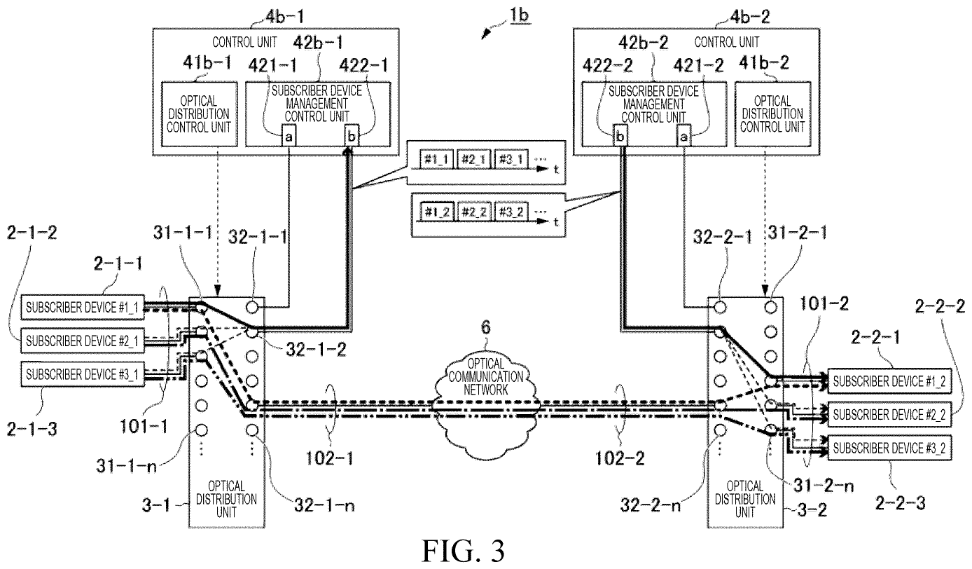

FIG. 3 is a diagram illustrating a configuration example of a communication system 1b in the modification example of the first embodiment. The communication system 1b includes one or more subscriber devices 2-1, an optical distribution unit 3-1, a control unit 4b-1, an optical transmission line group 101-1, and an optical transmission line group 102-1.

In addition, the communication system 1b includes one or more subscriber devices 2-2 facing one or more subscriber devices 2-1, an optical distribution unit 3-2, a control unit 4b-2, an optical transmission line group 101-2, and an optical transmission line group 102-2.

The subscriber device 2 is connected to an optical transmission line of the optical transmission line group 101. The optical distribution unit 3-1 is connected to the optical distribution unit 3-2 via the optical transmission line group 102-1, an optical communication network 6, and the optical transmission line group 102-2.

In FIG. 3, the optical distribution unit 3 performs wavelength multiplexing processing on the main signal light. The optical distribution unit 3-1 performs wavelength multiplexing processing on the main signal light input from a plurality of subscriber devices 2-1 by using a plurality of signal ports 31 and a single signal port 32. The optical distribution unit 3-1 transmits the wavelength-multiplexed main signal light to the optical communication network 6 from the single signal port 32.

In FIG. 3, the optical distribution unit 3 performs wavelength separation processing on the main signal light. The optical distribution unit 3-1 performs wavelength separation processing on the wavelength-multiplexed main signal light input from the optical communication network 6 by using the single signal port 32 and the plurality of signal ports 31. The optical distribution unit 3-1 outputs the wavelength-separated main signal light from a plurality of different signal ports 31 toward the subscriber device 2-1.

As described above, the optical distribution unit 3 performs the wavelength multiplexing processing on the main signal light input from the plurality of subscriber devices 2-1 by using the plurality of signal ports 31 and the single signal port 32. In addition, the optical distribution unit 3 performs wavelength separation processing on the wavelength-multiplexed main signal light input from the optical communication network 6 by using the single signal port 32 and the plurality of signal ports 31.

As a result, it is possible to transmit and receive the control signal between the subscriber device management control unit 42b and the subscriber device 2 after the opening of the optical path, with a simple system configuration as compared with the first embodiment.

### Second Embodiment

In the first embodiment, the subscriber device management control unit 42a includes the control port “a” for the subscriber device 2 before the opening of the optical path and the control port “b” for the subscriber device 2 after the opening of the optical path. On the other hand, a main difference of a second embodiment from the first embodiment is that a subscriber device management control unit includes a common control port “c” for the subscriber device 2 before the opening of the optical path and the subscriber device 2 after the opening of the optical path. In the second embodiment, differences from the first embodiment will be mainly described.

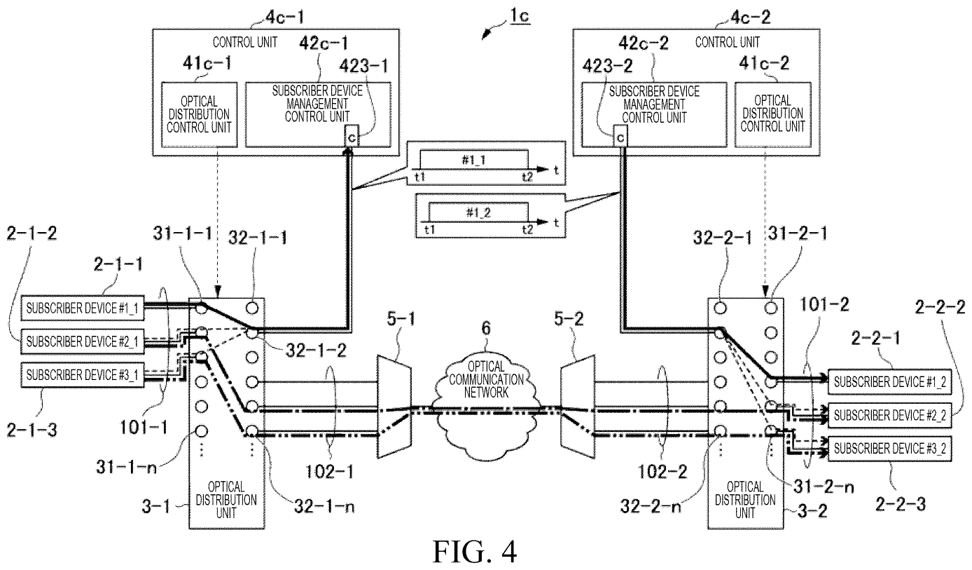

FIG. 4 is a diagram illustrating a configuration example of a communication system 1c before opening of an optical path, according to the second embodiment. The communication system 1c includes one or more subscriber devices 2-1, an optical distribution unit 3-1, a control unit 4c-1, a wavelength multiplexing/demultiplexing unit 5-1, an optical transmission line group 101-1, and an optical transmission line group 102-1.

Furthermore, the communication system 1c includes one or more subscriber devices 2-2 facing one or more subscriber devices 2-1, an optical distribution unit 3-2, a control unit 4c-2, a wavelength multiplexing/demultiplexing unit 5-2, an optical transmission line group 101-2, and an optical transmission line group 102-2.

The subscriber device 2 is connected to an optical transmission line of the optical transmission line group 101. In addition, the wavelength multiplexing/demultiplexing unit 5-1 is connected to the wavelength multiplexing/demultiplexing unit 5-2 via the optical transmission line group 102-1, an optical communication network 6, and the optical transmission line group 102-2.

### <Subscriber Device 2>

Before the opening of the optical path, in a predetermined communication permission period “period from a time t1 to a time t2”, the newly connected subscriber device 2-1-1 outputs uplink control signal light toward a control port 423-1 “c” of the subscriber device management control unit 42c-1. The uplink control signal light reaches the control port 423-1 “c” via a signal port 31-1 and a signal port 32-1 of the optical distribution unit 3-1. In addition, before the opening of the optical path, in the predetermined communication permission period “period from the time t1 to the time t2”, the newly connected subscriber device 2-1-1 receives downlink control signal light that is output from the control port 423-1 “c” of the subscriber device management control unit 42c and reaches the subscriber device 2-1-1 via the signal port 32-1 and the signal port 31-1 of the optical distribution unit 3-1.

<Optical Distribution Control Unit 41c>

In the predetermined communication permission period before the opening of the optical path, the optical distribution control unit 41c-1 changes the connection relationship between the signal port 31-1 and the signal port 32-1 in the optical distribution unit 3-1 such that the uplink control signal light transmitted from the newly connected subscriber device 2-1 is output toward the control port 423-1 “c”. In addition, in the predetermined communication permission period before the opening of the optical path, the optical distribution control unit 41c-1 changes a connection relationship between the signal port 31-1 and the signal port 32-1 in the optical distribution unit 3-1 such that the downlink control signal light transmitted from the control port 423-1 “c” is input to the newly connected subscriber device 2-1.

<Subscriber Device Management Control Unit 42c>

In the predetermined communication permission period before the opening of the optical path, the subscriber device management control unit 42c-1 receives uplink control signal light that has been transmitted from the newly connected subscriber device 2-1 and reaches the control port 423-1 “c” via the signal port 31-1 and the signal port 32-1 of the optical distribution unit 3-1. In addition, in the predetermined communication permission period before the opening of the optical path, the subscriber device management control unit 42c-1 outputs the downlink control signal light for a predetermined subscriber device 2-1 from the control port 423-1 “c” toward the destination subscriber device 2-1. The downlink control signal light reaches the destination subscriber device 2-1 via the signal port 32-1 and the signal port 31-1 of the optical distribution unit 3-1.

Before the opening of the optical path, the round trip time of the optical signal between the newly connected subscriber device 2-1 and the subscriber device management control unit 42c-1 may be measured in advance for each subscriber device 2-1. For example, the subscriber device management control unit 42c measures the round trip time of the optical signal in advance for each subscriber device 2-1 based on the propagation time of the uplink control signal light and the propagation time of the downlink control signal light.

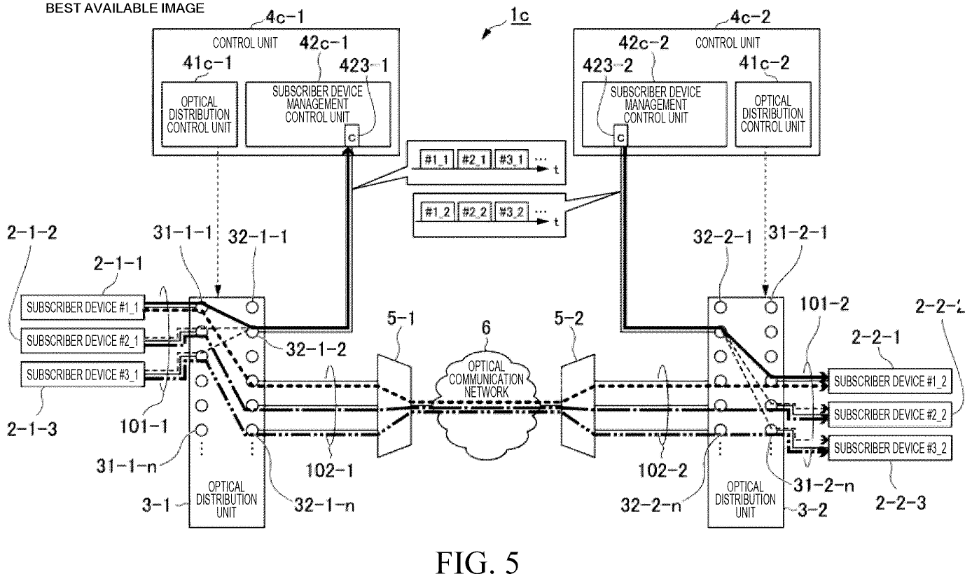

FIG. 5 is a diagram illustrating a configuration example of the communication system 1c after the opening of the optical path, in the second embodiment.

### <Subscriber Device 2>

After the opening of the optical path, a communication permission period “#k_1” of the uplink control signal and the downlink control signal is assigned to the subscriber device 2-1 for each subscriber device 2-1 by the subscriber device management control unit 42c-1. In the communication permission period “#k_1” assigned to the subscriber device 2-1, the subscriber device 2-1 receives the downlink control signal light that is output from the control port 423-1 “c” of the subscriber device management control unit 42c and reaches the subscriber device 2-1 via the signal port 32-1 and the signal port 31-1 of the optical distribution unit 3-1.

After the opening of the optical path, in the subscriber device 2-1, the uplink control signal light is transmitted toward the signal port 31-1 of the optical distribution unit 3-1 in the communication permission period “#k_1” of the uplink control signal and the downlink control signal assigned thereto. As a result, the uplink control signal light is transferred toward the control port 423-1 “c” of the subscriber device management control unit 42c via the signal port 31-1 and the signal port 32-1 of the optical distribution unit 3-1.

After the opening of the optical path, the subscriber device 2-1 transmits main signal light toward the facing subscriber device 2-2. After the opening of the optical path, the subscriber device 2-1 receives the main signal light that is output from the facing subscriber device 2-2 and reaches the subscriber device 2-1 via the signal port 32-1 and the signal port 31-1 of the optical distribution unit 3-1.

### <Optical Distribution Unit 3>

The optical distribution unit 3 in the second embodiment operates similarly to the optical distribution unit 3 in the first embodiment. For example, the optical distribution unit 3-1 distributes the optical signal input from the signal port 31-1 to the signal port 32-1 for each wavelength of the optical signal based on the connection relationship instructed from the optical distribution control unit 41c-1 for the signal port. In addition, the optical distribution unit 3-1 distributes the optical signal input from the signal port 32-1 to the signal port 31-1 for each wavelength of the optical signal based on the connection relationship instructed from the optical distribution control unit 41c-1 for the signal port.

<Optical Distribution Control Unit 41c>

After the opening of the optical path, the optical distribution control unit 41c-1 sets a connection relationship between the signal port 31 and the signal port 32 in the optical distribution unit 3-1 with respect to the wavelength of the main signal light such that the main signal light transmitted from the subscriber device 2-1 is input to the subscriber device 2-2 facing the subscriber device 2-1. In addition, after the opening of the optical path, the optical distribution control unit 41c-1 sets the connection relationship between the signal port 31 and the signal port 32 in the optical distribution unit 3-1 with respect to the wavelength of the main signal light such that the main signal light transmitted from the subscriber device 2-2 facing the subscriber device 2-1 is input to the subscriber device 2-1. The wavelength of the main signal light transmitted from the subscriber device 2-1 and the wavelength of the main signal light transmitted from the subscriber device 2-2 may be the same or different.

After the opening of the optical path, the optical distribution control unit 41c-1 dynamically changes the connection relationship between the signal port 31 and the signal port 32 in the optical distribution unit 3-1 with respect to the wavelength of the uplink control signal light under a predetermined condition based on the communication permission period assigned to each subscriber device 2 by the subscriber device management control unit 42c-1 such that the uplink control signal light transmitted from the subscriber device 2-1 is output toward the control port 423-1 “c”. For example, the optical distribution control unit 41c-1 dynamically changes the signal port 31-1 to which the uplink control signal light is transferred to and from the control port 423-1 “c”, under a predetermined condition.

After the opening of the optical path, the optical distribution control unit 41c-1 dynamically (for example, periodically) changes the connection relationship between the signal ports in the optical distribution unit 3-1 with respect to the wavelength of the downlink control signal under a predetermined condition based on the communication permission period assigned to each subscriber device 2 by the subscriber device management control unit 42c-1 such that the downlink control signal light obtained by time-division multiplexing the downlink control signals for the respective subscriber devices, which is transmitted from the control port 423-1 “c” is distributed and output toward the subscriber device 2-1 as a transmission destination of the downlink control signal. For example, the optical distribution control unit 41c-1 dynamically changes the signal port 31-1 to which the downlink control signal light is transferred to and from the control port 423-1 “c”, under a predetermined condition.

<Subscriber Device Management Control Unit 42c>

After the opening of the optical path, the subscriber device management control unit 42c-1 assigns the communication permission period “#_1” of the uplink control signal and the downlink control signal to each subscriber device 2-1 such that the uplink control signal and the downlink control signal are transmitted between the subscriber device 2-1 and the control port 423-1 “c”. In this case, the communication permission period “#k_1” may be assigned based on the round trip time of the optical signal. The communication permission periods “#k_1” of the uplink control signal and the downlink control signal may be different for each subscriber device 2-1.

In the communication permission period assigned to each subscriber device after the opening of the optical path, the subscriber device management control unit 42c-1 transmits the downlink control signal for the subscriber device 2-1 to which this communication permission period is assigned, from the control port 423-1 “c”.

In the communication permission period assigned to each subscriber device after the opening of the optical path, the uplink control signal light from the subscriber device 2-1 to which the communication permission period is assigned is received at the control port 423-1 “c” via the signal port 31-1 and the signal port 32-1 of the optical distribution unit 3-1.

In the communication permission period assigned to each subscriber device after the opening of the optical path, the subscriber device management control unit 42c-1 may transmit, from the control port 423-1 “c”, the downlink control signal for the subscriber device 2-1 to which the communication permission period is assigned, including an identifier indicating the subscriber device 2-1.

As described above, the control port 423 “c” is used to control the subscriber device before the opening of the optical path and the plurality of subscriber devices after the opening of the optical path. As a result, it is possible to transmit and receive the control signal between the subscriber device management control unit 42c and the subscriber device 2 after the opening of the optical path, without complicating the system configuration. Note that, similarly to the modification example of the first embodiment (similarly to FIG. 3), also in the second embodiment, the communication system 1c does not need to include the wavelength multiplexing/demultiplexing unit 5-1 and 5-2.

### First Modification Example of Second Embodiment

The optical distribution control unit 41c may detect that the subscriber device 2 is newly connected to the optical distribution unit 3. In a case where it is detected that the subscriber device 2 is newly connected to the optical distribution unit 3, the optical distribution control unit 41c may stop the dynamic change of the connection relationship between the signal port 31 and the signal port 32 to which the subscriber devices are connected after the opening of the optical path, in the optical distribution unit 3 during the communication permission period of the control signal from the time t1 to the time t2. In addition, the connection relationship between signal ports in the optical distribution unit 3 may be changed so that communication of the control signal can be performed between a plurality of newly connected subscriber devices 2 and the control port 423 “c”.

### Second Modification Example of Second Embodiment

Regardless of whether or not the subscriber device 2 is newly connected to the optical distribution unit 3, the optical distribution control unit 41c may periodically stop the dynamic change of the connection relationship between the signal port 31 and the signal port 32 to which the subscriber devices are connected after the opening of the optical path, in the optical distribution unit 3. In addition, a period (communication permission period from the time t1 to the time t2) during which communication of the control signal can be performed between a plurality of newly connected subscriber devices 2 and the control port 423 “c” may be provided in advance.

### (Hardware Configuration)

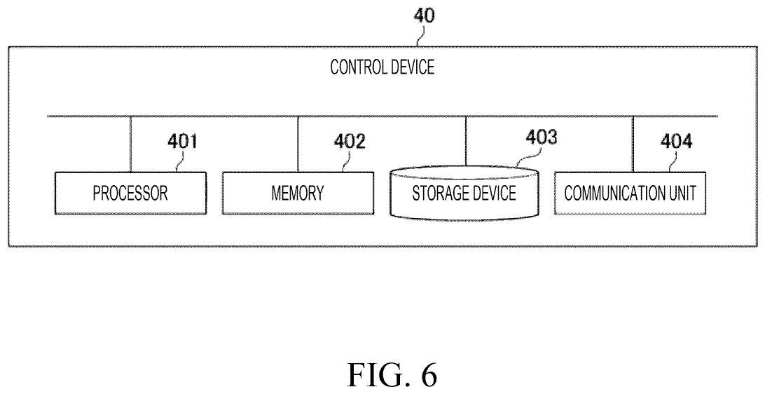

FIG. 6 is a diagram illustrating a hardware configuration example of the control device 40 in each embodiment. The control device 40 illustrated in FIG. 6 corresponds to the control unit 4a in the first embodiment, the control unit 4b in the modification example of the first embodiment, and the control unit 4c in the second embodiment.

The control device 40 is implemented as software by a processor 401 such as a central processing unit (CPU) executing a program stored in a storage device 403 including a nonvolatile recording medium (non-transitory recording medium) and a memory 402. The program may be recorded in a computer-readable recording medium. The computer-readable recording medium is, for example, a portable medium such as a flexible disk, a magneto-optical disc, read-only memory (ROM), or compact disc read-only memory (CD-ROM), or a non-transitory recording medium such as a storage device such as a hard disk or a solid state drive (SSD) built in a computer system. A communication unit 404 performs a predetermined communication process.

The control device 40 may be implemented by using hardware (accelerator) including an electronic circuit or circuitry using, for example, a large scale integrated circuit (LSI), an application specific integrated circuit (ASIC), a programmable logic device (PLD), or a field programmable gate array (FPGA).

While the embodiments of the present invention have been described in detail with reference to the drawings, specific configurations are not limited to these embodiments, and include designs and the like without departing from the spirit of the present invention.

### INDUSTRIAL APPLICABILITY

The present invention can be applied to optical communication systems.

Reference Signs List

| 1a, 1b, 1c | Communication system |
|---|---|
| 2 | Subscriber device |
| 3 | Optical distribution unit |
| 4a, 4b, 4c | Control unit |
| 5 | Wavelength multiplexing/demultiplexing unit |
| 6 | Optical communication network |
| 31 | Signal port |
| 32 | Signal port |
| 40 | Control device |
| 41a, 41b, 41c | Optical distribution control unit |
| 42a, 42b, 42c | Subscriber device management control unit |
| 100 | Optical transmission line group |
| 101 | Optical transmission line group |
| 102 | Optical transmission line group |
| 200 | Optical distribution unit |
| 300 | Optical distribution control unit |
| 400 | Subscriber device management control unit |
| 401 | Processor |
| 402 | Memory |
| 403 | Storage device |
| 404 | Communication unit |
| 421 | Control port |
| 422 | Control port |
| 423 | Control port |
| 500 | Optical transmission line group |
| 600 | Optical multiplexing/demultiplexing unit |

1. A control device comprising:
an optical distribution controller that dynamically changes connection between a plurality of signal ports in units of wavelengths such that downlink control signal light obtained by time-division multiplexing downlink control signals for respective subscriber devices, which are input from control ports to an optical distributor having the plurality of signal ports, is distributed and output toward destination subscriber devices of the downlink control signals, and dynamically changes the connection in units of wavelengths such that uplink control signal light obtained by time-multiplexing uplink control signal light input from the plurality of subscriber devices to the optical distributor is output to the control port; and
a subscriber device management controller that transmits, to the plurality of subscriber devices, an instruction of each timing at which the uplink control signal light is output toward the optical distributor, such that the uplink control signal light is output to the control port, wherein
a wavelength of main signal light output from the subscriber device toward the optical distributor is different from a wavelength of the uplink control signal light,
a wavelength of main signal light output from the optical distributor toward the subscriber device is different from a wavelength of the downlink control signal light, and
the optical distributor outputs the uplink control signal light to the control port and distributes the downlink control signal light toward a destination subscriber device for the downlink control signal.

2. The control device according to claim 1, wherein each timing is determined based on a round trip time of an optical signal between each of the plurality of subscriber devices and the control port.

3. A communication system comprising:
an optical distributor that has a plurality of signal ports;
an optical distribution controller that dynamically changes connection between the plurality of signal ports in units of wavelengths such that downlink control signal light obtained by time-division multiplexing downlink control signals for respective subscriber devices, which are input from control ports to the optical distributor, is distributed and output toward destination subscriber devices of the downlink control signals, and dynamically changes the connection in units of wavelengths such that uplink control signal light obtained by time-multiplexing uplink control signal light input from the plurality of subscriber devices to the optical distributor is output to the control port; and
a subscriber device management controller that transmits, to the plurality of subscriber devices, an instruction of each timing at which the uplink control signal light is output toward the optical distributor, such that the uplink control signal light is output to the control port, wherein
a wavelength of main signal light output from the subscriber device toward the optical distributor is different from a wavelength of the uplink control signal light,
a wavelength of main signal light output from the optical distributor toward the subscriber device is different from a wavelength of the downlink control signal light, and
the optical distributor outputs the uplink control signal light to the control port and distributes the downlink control signal light toward a destination subscriber device for the downlink control signal.

4. A control method performed by a control device, the control method comprising:
a step of dynamically changing connection between a plurality of signal ports in units of wavelengths such that downlink control signal light obtained by time-division multiplexing downlink control signals for respective subscriber devices, which are input from control ports to an optical distributor having the plurality of signal ports, is distributed and output toward destination subscriber devices of the downlink control signals, and dynamically changing the connection in units of wavelengths such that uplink control signal light obtained by time-multiplexing uplink control signal light input from the plurality of subscriber devices to the optical distributor is output to the control port; and
a step of transmitting, to the plurality of subscriber devices, an instruction of each timing at which the uplink control signal light is output toward the optical distributor, such that the uplink control signal light is output to the control port, wherein
a wavelength of main signal light output from the subscriber device toward the optical distributor is different from a wavelength of the uplink control signal light,
a wavelength of main signal light output from the optical distributor toward the subscriber device is different from a wavelength of the downlink control signal light, and
the step of changing includes outputting the uplink control signal light to the control port by the optical distributor and distributing the downlink control signal light toward a destination subscriber device for the downlink control signal by the optical distributor.
